(19) United States
(12) Patent Application Publication
(10) Pub. No.: US 2016/0149892 A1
(43) Pub. Date: May 26, 2016

(54) ELECTRONIC PASSWORD LOCK APPARATUS AND PASSWORD PROTECTION SYSTEM USING THE SAME

(71) Applicant: HON HAI PRECISION INDUSTRY CO., LTD., New Taipei (TW)

(72) Inventor: ZONG-YUAN SUN, New Taipei (TW)

(21) Appl. No.: 14/678,471

(22) Filed: Apr. 3, 2015

(30) Foreign Application Priority Data
Nov. 21, 2014 (CN) 201410677284.8

(51) Int. Cl. H04L 29/06

(52) U.S. Cl. CPC H04L 63/083; H04L 63/0876; H04L 63/0492

(57) ABSTRACT

An electronic password lock apparatus includes a storage unit, an input unit, and a communication unit. The storage unit stores a unique identification number of the electronic password lock apparatus, the electronic password lock apparatus is associated with a portable electronic device via the unique identification number. The input unit triggers a locking signal and an unlocking signal. The communication unit sends the locking signal or the unlocking signal to the portable electronic device to lock or unlock the portable electronic device, respectively, and receives an acknowledgement (ACK) signal from the portable electronic device to determine whether the portable electronic device is in a locking state or an unlocking state.

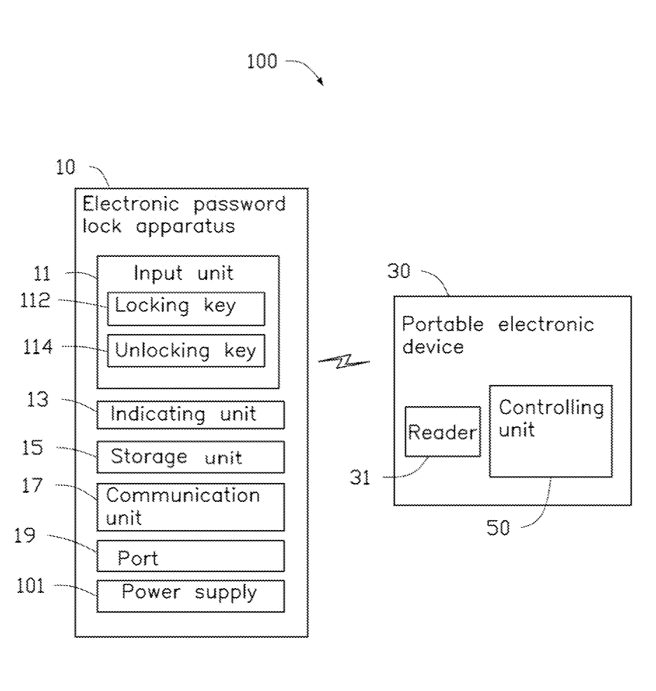

### FIELD

The subject matter herein generally relates to electronic apparatus, and particularly relates to an electronic apparatus for conveniently entering passwords.

### BACKGROUND

Personal digital assistants (PDAs), laptop computers, mobile phones, personal computers, and other electronic devices often have a password protection feature that prevents an unauthorized user from using the electronic device. The traditional password protection feature requires a user to physically enter a password into the electronic device before they can use the electronic device.

### BRIEF DESCRIPTION OF THE DRAWING

Implementations of the present technology will now be described, by way of example only, with reference to the attached figure.

The figure is a block diagram of a password protection system employing an electronic password lock apparatus, according to an exemplary embodiment.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawing is not necessarily to scale and the proportions of certain parts may be exaggerated to better illustrate details and features of the present disclosure.

A definition that applies throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a password protection system employing an electronic password lock apparatus.

The figure illustrates an embodiment of a password protection system 100 employing an electronic password lock apparatus 10 and a portable electronic device 30 wirelessly communicated with the electronic password lock apparatus 10. The portable electronic device 30 can be a mobile phone, a tablet, or an intelligent watch, for example (details are not shown).

The electronic password lock apparatus 10 has a radiation radius, when the portable electronic device 30 is in the radiation radius, the electronic password lock apparatus 10 communicates with the portable electronic device 30. For example, the electronic password lock apparatus 10 sends locking/unlocking signals to the portable electronic device 30 to lock/unlock the portable electronic device 30, respectively. When the portable electronic device 30 is out of the radiation radius, the portable electronic device 30 can be locked automatically, details will be illustrated below. In at least one embodiment, the electronic password lock apparatus 10 operates at a high frequency mode, an ultra high frequency mode, or around a central frequency of about 2.4 GHz. Optionally, the electronic password lock apparatus 10 has a unique identification number to be identified by the portable electronic device 30. Thus, the electronic password lock apparatus 10 can be associated with the portable electronic device 30 to prevent the portable electronic device 30 from being directing by other devices. In an exemplary embodiment, the electronic password lock apparatus 10 can be attached on clothes of users.

In detail, the electronic password lock apparatus 10 includes an input unit 11, an indicating unit 13, a storage unit 15, a communication unit 17, at least one port 19, and a power supply 101.

The input unit 11 at least includes a locking key 112 and an unlocking key 114. The locking key 112 is configured to trigger the locking signal in response to manipulation of the users for locking the portable electronic device 30, and the unlocking key 114 is configured to trigger the unlocking signal in response to manipulation of the users for unlocking the portable electronic device 30. In other embodiments, the input unit 11 can be a touch screen, and then the locking key 112 and the unlocking key 114 can be replaced by two prompt icons shown on the touch screen.

The indicating unit 13 is configured to indicate a locking state and an unlocking state of the portable electronic device 30 and also indicate a battery capacity of the electronic password lock apparatus 10. In at least one embodiment, the indicating unit 13 can have a first light emitting diode (LED) emitting blue lights, a second LED emitting green lights, and a third LED emitting orange lights. When the portable electronic device 30 is locked, the first LED is turned on, and the second LED is activated while the portable electronic device 30 is unlocked. The third LED is configured to indicate the battery capacity of the electronic password lock apparatus 10.

The storage unit 15 is configured to store a plurality of parameters and programs of the electronic password lock apparatus 10. In addition, the unique identification number of the electronic password lock apparatus 10 is pre-stored in the storage unit 15.

The communication unit 17 is a radio frequency (RF) tag operating at a central frequency of about 2.4 GHz. The communication unit 17 sends the locking signal and the unlocking signal to the portable electronic device 30, and then receive an acknowledgement (ACK) signal form the portable electronic device 30 to determine the locking state and the unlocking state of the portable electronic device 30.

The at least one port 19 is configured to couple to a card reader having a universal serial bus (USB) port, thus, the portable electronic device 30 can be mechanically coupled to the electronic password lock apparatus 10 via the card reader to set or reset the parameters and the programs of the electronic password lock apparatus 10. In at least one embodiment, the parameters and the programs at least include receiving/transmitting (R/T) frequencies and operating modes of the electronic password lock apparatus 10. Optionally, the operating modes of the electronic password lock apparatus 10 can include a working mode and a sleep mode. When the electronic password lock apparatus 10 is in the working mode, the electronic password lock apparatus 10 works at a first R/T frequency. When the electronic password lock apparatus 10 is in the sleep mode, the electronic password lock apparatus 10 works at a second R/T frequency which is less than the first R/T frequency. In other embodiments, the electronic password lock apparatus 10 can be set or reset by the portable electronic device 30 via wirelessly manners. For example, the portable electronic device 30 sends commands to the electronic password lock apparatus 10 via the communication unit 17 to set or reset the parameters and the programs of the electronic password lock apparatus 10.

In addition, when the portable electronic device 30 is not operated for a period of time, the portable electronic device 30 enters the locking state and sends the ACK signal to the electronic password lock apparatus 10, thereby controlling the electronic password lock apparatus 10 to enter the sleep mode for conserving power.

The power supply 101 can be a rechargeable battery and is configured to provide power to the input unit 11, the indicating unit 13, the storage unit 15, the communication unit 17, and the at least one port 19. When the power supply 101 is exhausted, the third LED is lit to indicate voltage insufficient of the power supply 101.

The portable electronic device 30 includes a reader 31 and an controlling unit 50. When the portable electronic device 30 is in the radiation radius of the electronic password lock apparatus 10, the reader 31 communicates with the communication unit 17 to receive the locking signal and the unlocking signal from the electronic password lock apparatus 10 and send the ACK signal to the electronic password lock apparatus 10. In at least one embodiment, the reader 31 can be a radio frequency identification (RFID) reader.

The controlling unit 50 is configured to lock/unlock the portable electronic device 30 according to the locking signal and the unlocking signal, respectively. In addition, when the portable electronic device 30 is out of the radiation radius of the electronic password lock apparatus 10 or the portable electronic device 30 is not operated for the period of time, the portable electronic device 30 is locked by the controlling unit 50. Further, the controlling unit 50 is also configured to identify the unique identification number of the electronic password lock apparatus 10 to allow the portable electronic device 30 to be associated with the electronic password lock apparatus 10. Thus, the controlling unit 50 can further set or reset the electronic password lock apparatus 10 via the card reader.

In summary, the password protection system 100 includes the portable electronic device 30 and the electronic password lock apparatus 10 separately and wirelessly communicated with the portable electronic device 30. Thus, the portable electronic device 30 can be locked/unlocked by the electronic password lock apparatus 10. Additionally, when a distance between the portable electronic device 30 and the electronic password lock apparatus 10 is greater than the radiation radius of the electronic password lock apparatus 10, the portable electronic device 30 will be locked by itself. Therefore, double security can be added to portable electronic device 30, and the password protection system 100 is both efficient and convenient.

The embodiments shown and described above are only examples. Many details are often found in the art such as the other features of the password protection system employing the electronic password lock apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic password lock apparatus comprising:
a storage unit storing a unique identification number of the electronic password lock apparatus, the electronic password lock apparatus associated with a portable electronic device via the unique identification number;
an input unit configured to trigger at least one of a locking signal or an unlocking signal; and
a communication unit configured to transmit one of the locking signal or the unlocking signal to the portable electronic device to respectively lock or respectively unlock the portable electronic device, the communication unit further configured to receive an acknowledgement (ACK) signal from the portable electronic device to determine whether the portable electronic device is in a locking state or an unlocking state.

2. The electronic password lock apparatus as claimed in claim 1, wherein the input unit comprises a locking key and an unlocking key, the locking key triggers the locking signal in response to manipulation of users for locking the portable electronic device, and the unlocking key triggers the unlocking signal in response to manipulation of the users for unlocking the portable electronic device.

3. The electronic password lock apparatus as claimed in claim 1, further comprising an indicating unit, wherein the indicating unit indicates the locking state or the unlocking state of the portable electronic device and indicates a battery capacity of the electronic password lock apparatus.

4. The electronic password lock apparatus as claimed in claim 1, further comprising at least one port, wherein the at least one port is coupled to the portable electronic device to receive parameters and programs of the electronic password lock apparatus from the portable electronic device, and the parameters and the programs are stored in the storage unit.

5. The electronic password lock apparatus as claimed in claim 4, wherein the parameters and the programs at least include receiving/transmitting (R/T) frequencies and operating modes of the electronic password lock apparatus.

6. The electronic password lock apparatus as claimed in claim 5, wherein the operating modes of the electronic password lock apparatus include a working mode and a sleep mode, when the electronic password lock apparatus is in the working mode, the electronic password lock apparatus works at a first R/T frequency, when the electronic password lock apparatus is in the sleep mode, the electronic password lock apparatus works at a second R/T frequency which is less than the first R/T frequency.

7. The electronic password lock apparatus as claimed in claim 1, wherein the communication unit is a radio frequency (RF) tag operating at a central frequency of about 2.4 GHz.

8. A password protection system comprising:
a portable electronic device; and
an electronic password lock apparatus separately and wirelessly communicated with the portable electronic device, the electronic password lock apparatus comprising:
a storage unit storing a unique identification number of the electronic password lock apparatus, the electronic password lock apparatus associated with the portable electronic device via the unique identification number;
an input unit configured to trigger at least one of a locking signal or an unlocking signal; and
a communication unit configured to transmit one of the locking signal or the unlocking signal to the portable electronic device, the communication unit further configured to receive an acknowledgement (ACK) signal from the portable electronic device to determine whether the portable electronic device is in a locking state or an unlocking state;
wherein the portable electronic device comprises an controlling unit, the controlling unit locks/unlocks the portable electronic device according to the locking signal and the unlocking signal, respectively.

9. The password protection system as claimed in claim 8, wherein the electronic password lock apparatus has a radiation radius, when the portable electronic device is in the radiation radius, the electronic password lock apparatus sends the locking signal or the unlocking signals to the portable electronic device to lock or unlock the portable electronic device, respectively, when the portable electronic device is out of the radiation radius, the portable electronic device is locked by the controlling unit.

10. The password protection system as claimed in claim 9, wherein the input unit comprises a locking key and an unlocking key, the locking key triggers the locking signal in response to manipulation of users for locking the portable electronic device, and the unlocking key triggers the unlocking signal in response to manipulation of the users for unlocking the portable electronic device.

11. The password protection system as claimed in claim 8, wherein the electronic password lock apparatus further comprises an indicating unit, the indicating unit indicates the locking state or the unlocking state of the portable electronic device and indicates a battery capacity of the electronic password lock apparatus.

12. The password protection system as claimed in claim 8, wherein the electronic password lock apparatus further comprises at least one port, the at least one port is coupled to the portable electronic device to receive parameters and programs of the electronic password lock apparatus from the portable electronic device, and the parameters and the programs are stored in the storage unit.

13. The password protection system as claimed in claim 12, wherein the parameters and the programs at least include receiving/transmitting (R/T) frequencies and operating modes of the electronic password lock apparatus.

14. The password protection system as claimed in claim 13, wherein the operating modes of the electronic password lock apparatus include a working mode and a sleep mode, when the electronic password lock apparatus is in the working mode, the electronic password lock apparatus works at a first R/T frequency, when the electronic password lock apparatus is in the sleep mode, the electronic password lock apparatus works at a second R/T frequency which is less than the first R/T frequency.

15. The password protection system as claimed in claim 8, wherein the portable electronic device further comprises a reader, the reader communicates with the electronic password lock apparatus to receive the locking signal and the unlocking signal and sends the ACK signal to the electronic password lock apparatus.

16. The password protection system as claimed in claim 8, wherein the controlling unit locks the portable electronic device when the portable electronic device is not operated for a period of time.

17. The password protection system as claimed in claim 8, wherein the controlling unit identifies the unique identification number of the electronic password lock apparatus to allow the portable electronic device to be associated with the electronic password lock apparatus.
